(19) United States
(12) Patent Application Publication
(10) Pub. No.: US 2026/0217173 A1
(43) Pub. Date: Jul. 30, 2026

(54) VEHICLE ARMRESTS WITH EXTENDABLE PANEL ASSEMBLIES AND METHODS THEREFOR

(71) Applicant: GM GLOBAL TECHNOLOGY OPERATIONS LLC, Detroit, MI (US)

(72) Inventors: Taekgeun Lee, Geumcheon-gu (KR); Minsu Lee, Gyeonggi-do (KR); Seokju Yong, Bucheon-si (KR); Ilmin Hong, Incheon (KR)

(73) Assignee: GM GLOBAL TECHNOLOGY OPERATIONS LLC, Detroit, MI (US)

(21) Appl. No.: 19/036,106

(22) Filed: Jan. 24, 2025

(51) Int. Cl. B60N 2/75; B60N 3/00; B60N 3/10

(52) U.S. Cl. CPC B60N 2/757; B60N 2/793; B60N 3/002; B60N 3/102

(57) ABSTRACT

Armrests for vehicles and methods of using the armrests are provided. The armrests include a body having a rear end configured to be pivotally coupled to a seatback of a bench seat of the vehicle, a front end opposite the rear end, and sides therebetween, wherein the body is configured to be pivotable between at least a stowed configuration and a deployed configuration while pivotably coupled to the seatback, wherein the body is disposed within a recess of the seatback while in the stowed configuration and disposed outside of the recess when in the deployed configuration, and a panel assembly slidably coupled with the body with a rail assembly, wherein the panel assembly is configured to extend and retract from at least one of the sides of the body and to support a load thereon while extended from the at least one of the sides of the body.

### INTRODUCTION

The technical field generally relates to vehicle seats, and more particularly relates to armrests for vehicle seats that include extendable panel assemblies capable of unfolding to dispose a portion thereof over the vehicle seats and support a load thereon.

Contemporary automobiles offer a range of amenities designed to enhance the comfort of their occupants. Examples of these features include adjustable seats that can be customized to accommodate specific occupants, including adjustments for seat height, recline angle, lumbar support, and headrest height.

However, there is an ongoing desire to provide systems and methods capable of further promoting occupant comfort while in a vehicle. Furthermore, other desirable features and characteristics of the present disclosure will become apparent from the subsequent detailed description and the appended claims, taken in conjunction with the accompanying drawings and the foregoing introduction.

### SUMMARY

A method is provided for supporting a load from an armrest of a vehicle. In one example, the method includes pivoting an armrest coupled to a bench seat of the vehicle from a stowed configuration to a deployed configuration, wherein the armrest is within a recess of a seatback of the bench seat while in the stowed configuration and disposed outside of the recess when in the deployed configuration, extending a panel assembly from a side of the armrest, and supporting the load on the panel assembly while extended from the side of the armrest.

In various examples, extending the panel assembly from the side of the armrest may include extending the panel assembly from the armrest in a direction toward a side of the vehicle to be disposed over a side seat cushion of the bench seat.

In various examples, the panel assembly may include a first panel member and a second panel member, wherein the first panel member is coupled to the second panel member and the second panel member is secured to a body of the armrest with a rail assembly. In such examples, extending the panel assembly from the side of the armrest may include sliding the second panel member along the rail assembly.

In various examples, the method may include transitioning the panel assembly between a folded configuration and an unfolded configuration while the panel assembly is extended from the side of the armrest, wherein the first panel member and the second panel member are stacked while in the folded configuration and the first panel member is cantilevered from the second panel member while in the unfolded configuration to, in combination, define a support surface configured to support the load thereon.

In various examples, the first panel member and the second panel member may be coupled with a pivot joint, and the method may include transitioning the panel assembly to the unfolded configuration by pivoting the first panel member relative to the second panel member such that adjacent faces of the first panel member and the second panel member are aligned in a geometric plane. In various examples, the first panel member and the second panel member may be coupled with the pivot joint at forward edges thereof and the method may include pivoting the first panel member relative to the second panel member to be disposed in a position that is closer to the front of the vehicle.

In various examples, the method may include extending the panel assembly from a second side of the armrest, and supporting the load on the panel assembly while extended from the second side of the armrest.

In various examples, the method may include releasably securing the armrest in a first position when pivoted relative to the seatback.

An armrest is provided for a bench seat of a vehicle. In one example, the armrest includes a body having a rear end configured to be pivotally coupled to a seatback of the bench seat, a front end opposite the rear end, and sides therebetween, wherein the body is configured to be pivotable between at least a stowed configuration and a deployed configuration while pivotably coupled to the seatback, wherein the body is disposed within a recess of the seatback while in the stowed configuration and disposed outside of the recess when in the deployed configuration, and a panel assembly slidably coupled with the body with a rail assembly, wherein the panel assembly is configured to extend and retract from at least one of the sides of the body and to support a load thereon while extended from the at least one of the sides of the body.

In various examples, the panel assembly of the armrest may include a first panel member and a second panel member, wherein the first panel member is coupled to the second panel member and the second panel member is secured to the body with the rail assembly.

In various examples, the panel assembly of the armrest may be configured to transition between a folded configuration and an unfolded configuration while the panel assembly is extended from the at least one of the sides of the body, wherein the first panel member and the second panel member are stacked while in the folded configuration and the first panel member is cantilevered from the second panel member while in the unfolded configuration to, in combination, define a support surface configured to support the load thereon.

In various examples, the first panel member and the second panel member of the armrest may be coupled with a pivot joint, and the panel assembly may be configured to transition to the unfolded configuration by pivoting the first panel member relative to the second panel member such that adjacent faces of the first panel member and the second panel member are aligned in a geometric plane.

In various examples, the first panel member and the second panel member of the armrest may be coupled with the pivot joint at forward edges thereof and the first panel member may be configured to pivot relative to the second panel member to be disposed in a position that is closer to the front of the vehicle while the body is coupled to the bench seat within the vehicle.

In various examples, the panel assembly of the armrest may be configured to extend from both of the sides of the body.

In various examples, the rear end of the body of the armrest may include a pivoting joint that is configured to be pivotably coupled to the seatback and releasably securable in more than one position when pivoted relative to the seatback.

A vehicle is provided that, in one example, includes a bench seat having a first seat cushion, a second seat cushion, a middle seat cushion between the first seat cushion and the second seat cushion, and a seatback for supporting an occupant’s back while seated in the first seat cushion, the second seat cushion, or the middle seat cushion, and an armrest that includes a body having a rear end pivotally coupled to the seatback of the bench seat, a front end opposite the rear end, and sides therebetween, wherein the body is configured to be pivotable between at least a stowed configuration and a deployed configuration, wherein the body is disposed within a recess of the seatback while in the stowed configuration and disposed outside of the recess when in the deployed configuration, and a panel assembly slidably coupled with the body with a rail assembly, wherein the panel assembly is configured to extend and retract from at least one of the sides of the body and to support a load thereon while extended from the at least one of the sides of the body, wherein the panel assembly is configured to extend from the at least one of the sides of the body in directions toward and away from sides of the vehicle and to be disposed over the first seat cushion of the second seat cushion.

In various examples, the panel assembly of the vehicle may include a first panel member and a second panel member, wherein the first panel member is coupled to the second panel member and the second panel member is secured to the body with the rail assembly, wherein the panel assembly is configured to transition between a folded configuration and an unfolded configuration while the panel assembly is extended from the at least one of the sides of the body, wherein the first panel member and the second panel member are stacked while in the folded configuration and the first panel member is cantilevered from the second panel member while in the unfolded configuration to, in combination, define a support surface configured to support the load thereon.

In various examples, the first panel member and the second panel member of the vehicle may be coupled with a pivot joint, and the panel assembly may be configured to transition to the unfolded configuration by pivoting the first panel member relative to the second panel member such that adjacent faces of the first panel member and the second panel member are aligned in a geometric plane.

In various examples, the panel assembly of the vehicle may be configured to extend from both of the sides of the body.

In various examples, the rear end of the body may include a pivoting joint that is pivotably coupled to the seatback and releasably securable in more than one position when pivoted relative to the seatback.

### BRIEF DESCRIPTION OF THE DRAWINGS

The exemplary embodiments will hereinafter be described in conjunction with the following drawing figures, wherein like numerals denote like elements, and wherein:

FIG. 1 is a functional block diagram representing a vehicle that includes an armrest having an extendable panel assembly in accordance with an example;

FIGS. 2 and 3 represent an occupant seated in the vehicle of FIG. 1 and using the extendable panel assembly thereof in accordance with examples;

FIG. 4 is an isolated, perspective view representing the armrest of FIGS. 1-3 in an as-deployed arrangement in accordance with an example.

FIG. 5 is an isolated, perspective view representing the armrest of FIGS. 1-4 depicting a lid thereof in an open position and a cup holder thereof extended therefrom in accordance with examples;

FIGS. 6 and 7 are isolated, perspective views representing the armrest of FIGS. 1-5 depicting the panel assembly extended from first and second sides thereof, respectively, and arranged in unfolded configurations that extend toward side of the vehicle in accordance with examples;

FIGS. 8 and 9 are isolated, perspective views representing the armrest of FIGS. 1-5 depicting the panel assembly extended from first and second sides thereof, respectively, and arranged in unfolded configurations that extend toward a front of the vehicle in accordance with examples;

FIG. 10 is an isolated, perspective view representing the panel assembly of the armrest of FIGS. 1-6 in accordance with an example;

FIG. 11 is an isolated, perspective view representing the panel assembly of the armrest of FIGS. 1-5, 8, and 9 in accordance with an example;

FIG. 12 is an isolated, perspective view representing the panel assembly of the armrest of FIGS. 1-5, 8, 9, and 11 in accordance with an example;

FIG. 13 is an isolated, side view representing the panel assembly of the armrest of FIGS. 1-12 in various releasably securable positions in accordance with an example; and

FIG. 14 is a flowchart illustrating steps of a method for supporting a load from an armrest of a vehicle in accordance with an example.

### DETAILED DESCRIPTION

The following detailed description is merely exemplary in nature and is not intended to limit the application and uses. Furthermore, there is no intention to be bound by any expressed or implied theory presented in the preceding introduction or the following detailed description.

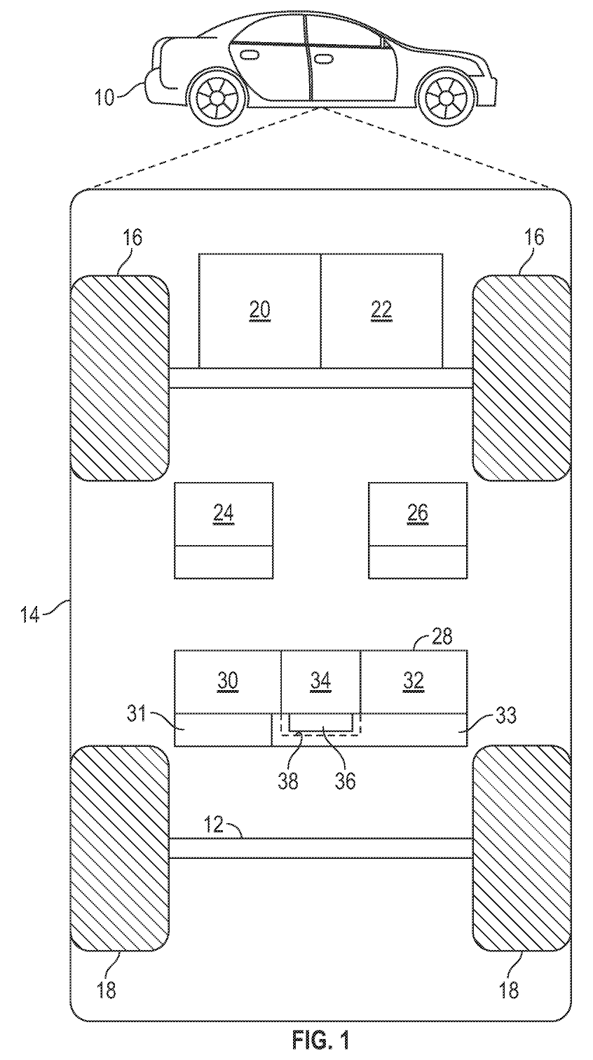

FIG. 1 illustrates a vehicle 10 that includes an armrest 36 configured to provide an extendable support surface, according to an example. In certain examples, the vehicle 10 comprises an automobile. In various examples, the vehicle 10 may be any one of a number of different types of automobiles, such as, for example, a sedan, a wagon, a truck, or a sport utility vehicle (SUV), and may be two-wheel drive (2WD) (i.e., rear-wheel drive or front-wheel drive), four-wheel drive (4WD) or all-wheel drive (AWD), and/or various other types of vehicles or mobile platforms in certain examples.

As depicted in FIG. 1, the exemplary vehicle 10 generally includes a chassis 12, a body 14, front wheels 16, and rear wheels 18. The body 14 is arranged on the chassis 12 and substantially encloses components of the vehicle 10. The body 14 and the chassis 12 may jointly form a frame. The wheels 16, 18 are each rotationally coupled to the chassis 12 near a respective corner of the body 14. The vehicle 10 may include a propulsion system 20 and a transmission system 22. The propulsion system 20 includes an engine and/or motor such as an internal combustion engine (e.g., a gasoline or diesel fueled combustion engine), an electric motor (e.g., a 3-phase AC motor), or a hybrid system that includes more than one type of engine and/or motor. The transmission system 22 is configured to transmit power from the propulsion system 20 to the wheels 16, 18 according to selectable speed ratios. According to various examples, the transmission system 22 may include a step-ratio automatic transmission, a continuously-variable transmission, or other appropriate transmission.

The vehicle 10 may include front seats 24, 26 and one or more rear seats 28 each configured to support an occupant of the vehicle 10 sitting thereon. In this example, the vehicle 10 includes two rows of seats; however, the vehicle 10 may include one or more additional rows of seats such as a third row. Each of the seats 24, 26, 28 may include a frame (not shown) secured to a floor of the vehicle 10, a seat base or seat cushion coupled to the frame, a seatback secured at a lower end thereof to the seat cushion and/or the frame, and a headrest secured to an upper end of the seatback. The seat cushion may be configured to support a rear and/or thighs of the occupant seated thereon, the seatback may be configured to support the occupant’s back while seated on the seat cushion, and the headrest may be configured to support the occupant’s head. The seats 24, 26, 28 may include various components that provide for adjustment thereof, such as systems for adjusting a height of the seats 24, 26, 28 relative to the vehicle floor, a recline angle of the seatback, lumbar support, and a height of the headrest relative to an upper end of the seatback. In this example, the armrest 36 is included in the rear seat 28.

In the examples of FIGS. 1-3, the rear seat 28 is configured as a bench-type seat, specifically a 60/40 split bench seat configured to seat up to three passengers. More specifically, the rear seat 28 includes a first seat cushion 30, a second seat cushion 32, and a middle seat cushion 34 therebetween. A first seatback 31 is pivotably coupled relative to the first seat cushion 30 and a second seatback 33 is pivotably coupled relative to the second seat cushion 32 and the middle seat cushion 34. Notably, configurations other than represented in the drawings are possible. For example, the rear seat 28 may be a 40/20/40 split bench seat.

The second seatback 33 includes a recess 38 therein configured to store a deployable rear seat armrest 36. The armrest 36 is pivotally coupled to the second seatback 33 and is configured to be selectively positioned in a stowed configuration, a deployed configuration, and, optionally, one or more positions therebetween. While in the stowed configuration, the armrest 36 is disposed within the recess 38 and exposed portions of the armrest 36 may be substantially aligned, flush, or otherwise contoured relative to adjacent surfaces of the second seatback 33 to define a single, combined seatback. That is, while in the stowed configuration, the armrest 36 and the second seatback 33 may, in combination, provide an appearance and/or functionality similar to a seatback of a comparable, existing 60/40 split bench seat that does not include the armrest 36, for example, that includes a single integral body.

While in the deployed configuration, the armrest 36 may be disposed over the middle seat cushion 34 and, optionally, in contact with and resting on the middle seat cushion 34. In various examples, the armrest 36 may be configured to be secured in one or more configurations between the stowed configuration and the deployed configuration. For example, the armrest 36 may be coupled to the second seatback 33 with a joint capable of being locked or ratcheted between one or more positions.

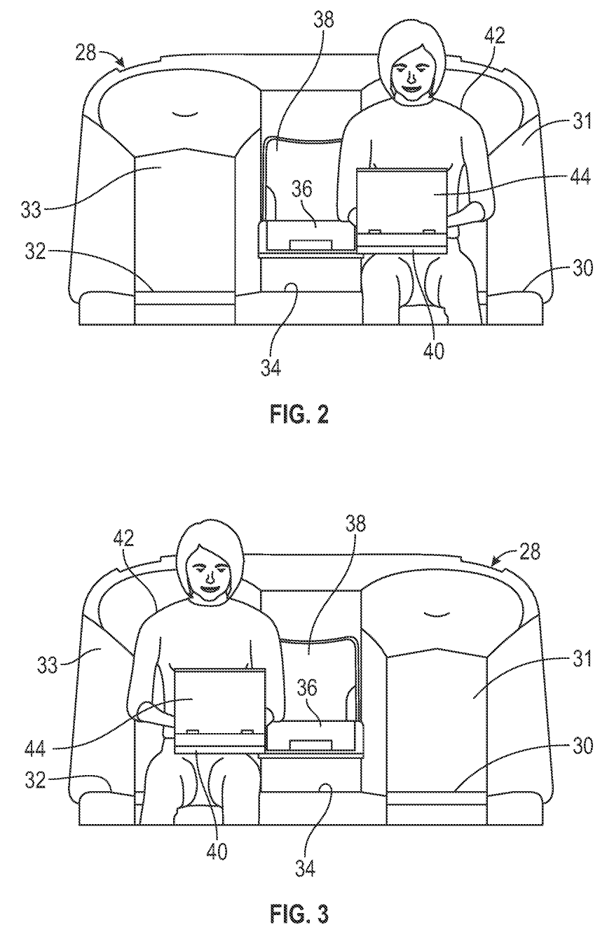

While in the deployed configuration or a configuration between the stowed configuration and the deployed configuration, the armrest 36 may provide various functions to occupants seated in the first seat cushion 30 and/or the second seat cushion 32, including but not limited to an armrest, a cup holder, storage device, etc. In various examples, the armrest 36 may be configured to provide a functionality similar to a table, desk or the like, wherein a load supporting surface is disposed over an occupant’s lap and capable of supporting objects thereon. For example, FIGS. 2 and 3 represent an occupant 42 seated on the first seat cushion 30 and the second seat cushion 32, respectively. The occupant 42 is depicted as using a laptop computer 44 that is resting on a panel assembly 40 extending and cantilevered from the armrest 36.

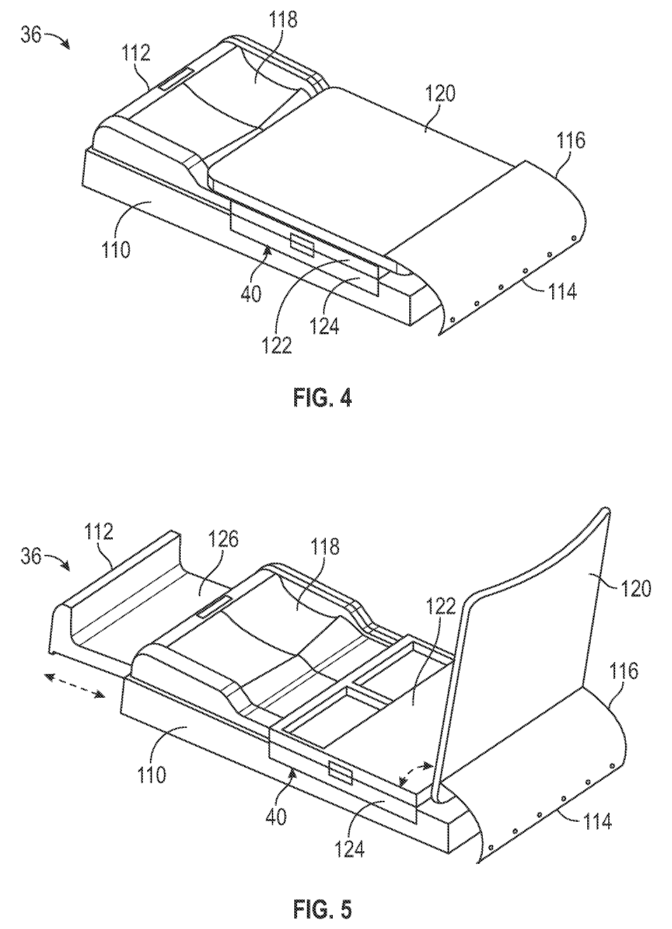

Referring now to FIGS. 4-9, and with continued reference to FIGS. 1-3, isolated, perspective views of the armrest 36 according to certain examples are provided wherein the armrest 36 is disposed in the deployed configuration. In these figures, the armrest 36 is depicted with components thereof in various arrangements. FIG. 4 represents the armrest 36 in an as-deployed arrangement. The armrest 36 includes a base 110, a front end 112, a rear end 114, a hinge portion 116, an optional tray portion 118, and a lid 120. FIG. 5 represents the lid 120 opened (e.g., by pivoting about a joint at a rear end thereof) to reveal a storage area therebelow that includes one or more compartments defined in a first panel member 122. FIG. 5 further represents a cup holder member 126 as extended from the front end 112. The cup holder member 126 may be configured to slide into and from a corresponding recess in the base 110.

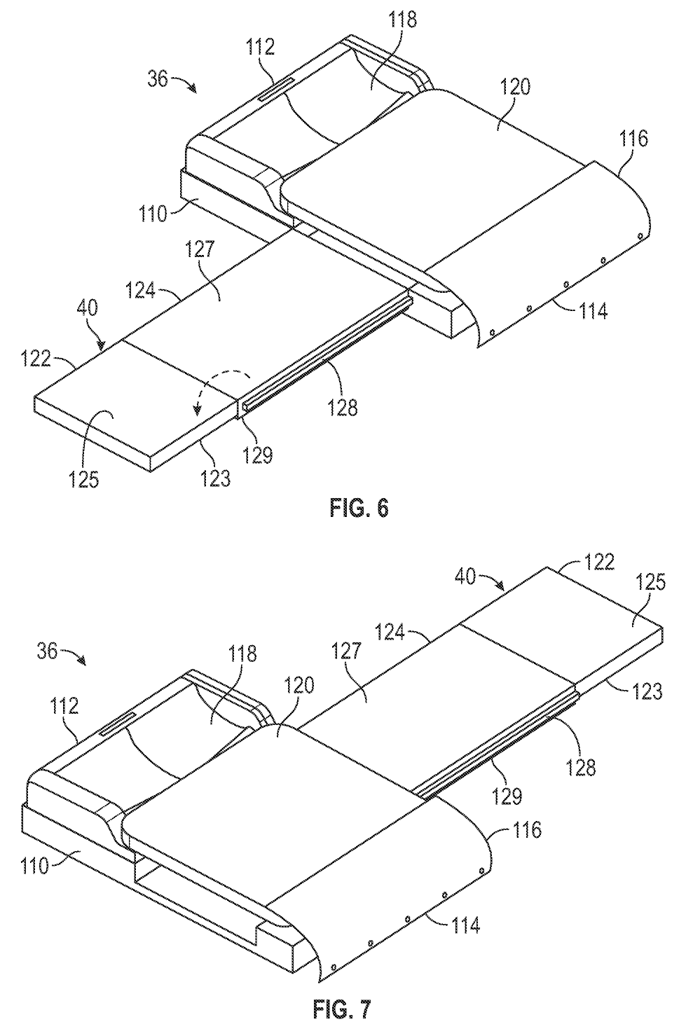

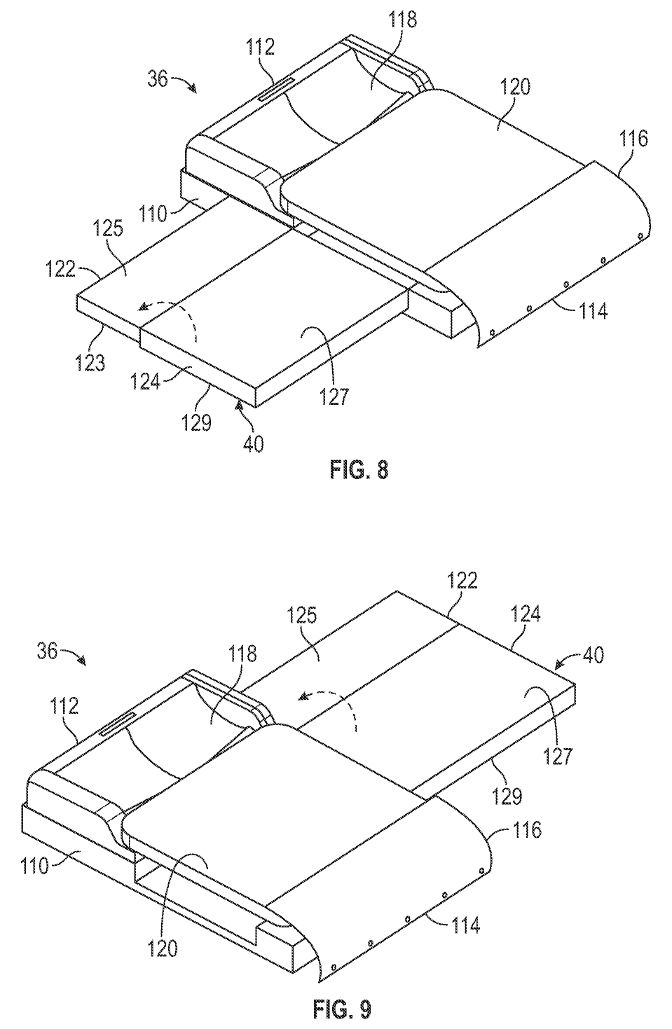

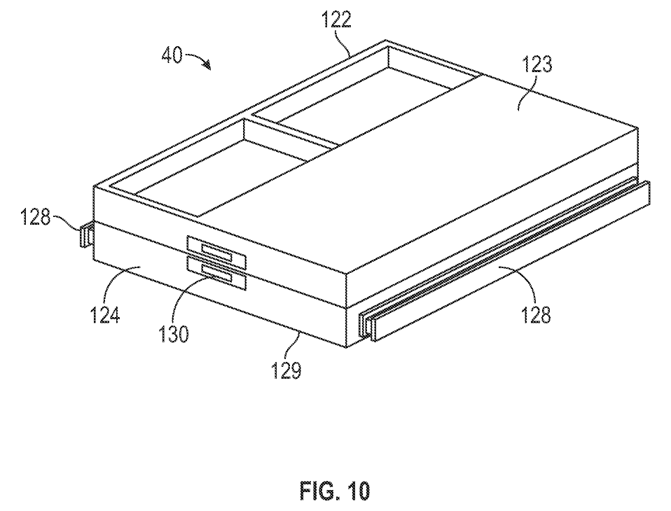

FIGS. 6-9 represent the armrest 36 with the panel assembly 40 extending therefrom, and FIG. 10 represents a perspective, isolated view of the panel assembly 40 for clarity. In this example, the panel assembly 40 is configured to slide into and out of a channel defined through the base 110 from either side thereof. Specifically, FIGS. 6 and 8 represent the panel assembly 40 as extending from a first side of the base 110 (i.e., over the first seat cushion 30) and FIGS. 7 and 9 represent the panel assembly 40 as extending from a second side of the base 110 (i.e., over the second seat cushion 32). The panel assembly 40 may be slidably coupled to the base 110 with rail assemblies 128. In this example, the rail assemblies 128 are bidirectional rail assemblies configured to slide in two directions relative to a retracted position (i.e., midpoint) between oppositely disposed fully extended positions. Optionally, the rail assemblies 128 may be configured to lock or be retainable in the retracted position, fully extended positions, and/or positions therebetween.

The panel assembly 40 may include a single panel member, or more than one panel member configured to unfold relative to each other and thereby define, in combination, an enlarged surface area. In the example of FIGS. 6-10, the panel assembly 40 includes the first panel member 122 and a second panel member 124 that are coupled at a common edge thereof with a pivoting joint 130. For ease of description, the first panel member 122 will be referred to as having a rectangular body with a first face 123, a second face 125 opposite the first face 123, front and rear edges facing the front and rear of the vehicle 10 when the armrest 36 is in the deployed configuration, and lateral edges facing sides of the vehicle 10 when the armrest 36 is in the deployed configuration. Similarly, the second panel member 124 will be referred to as having a rectangular body with a third face 127, a fourth face 129 opposite the third face 127, front and rear edges facing the front and rear of the vehicle 10 when the armrest 36 is in the deployed configuration, and lateral edges facing sides of the vehicle 10 when the armrest 36 is in the deployed configuration. It should be understood that the first panel member 122 and/or the second panel member 124 may have shapes other than those represented in the figures.

The panel assembly 40 is configured to transition between a folded configuration (FIGS. 1-5 and 10-12) and an unfolded configuration (FIGS. 6-9). In the folded configuration, the first panel member 122 and the second panel member 124 are stacked, that is, the first panel member 122 is disposed on the second panel member 124 with the second face 125 and the third face 127 in contact or otherwise adjacent and directed toward each other. The rail assemblies 128 are secured to the second panel member 124 for sliding the entire panel assembly 40 relative to the base 110. In the unfolded configuration, the first panel member 122 and the second panel member 124 are disposed edges thereof adjacent to each other such that the second face 125 and the third face 127 are aligned within the same geometric plane (i.e., flush). The manner in which the first panel member 122 and the second panel member 124 transition into the unfolded configuration may vary depending on the application.

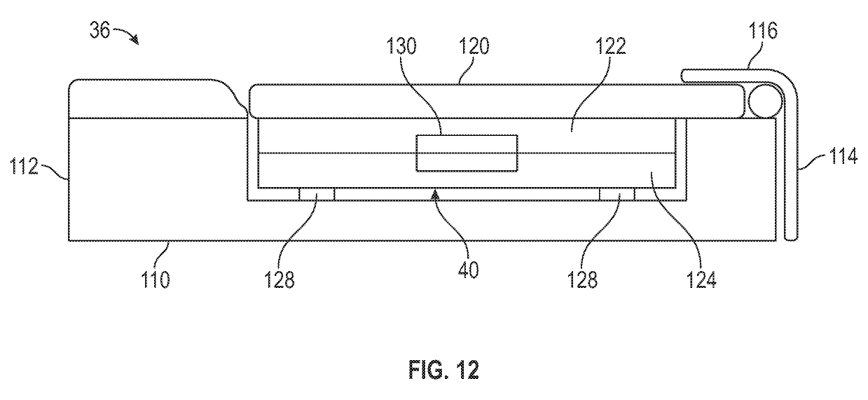

In the examples of FIGS. 6 and 7, the first panel member 122 and the second panel member 124 are pivotally coupled at the lateral edges thereof such that the first panel member 122 is capable of unfolding (via pivoting) in directions toward sides of the vehicle 10 to enlarge the support surface provided by the panel assembly 40. In such examples, the rail assemblies 128 may be secured to forward and rearward edges of the second panel member 124 as represented in FIGS. 6, 7, and 10, or alternatively may be secured to the fourth face 129 (FIG. 12).

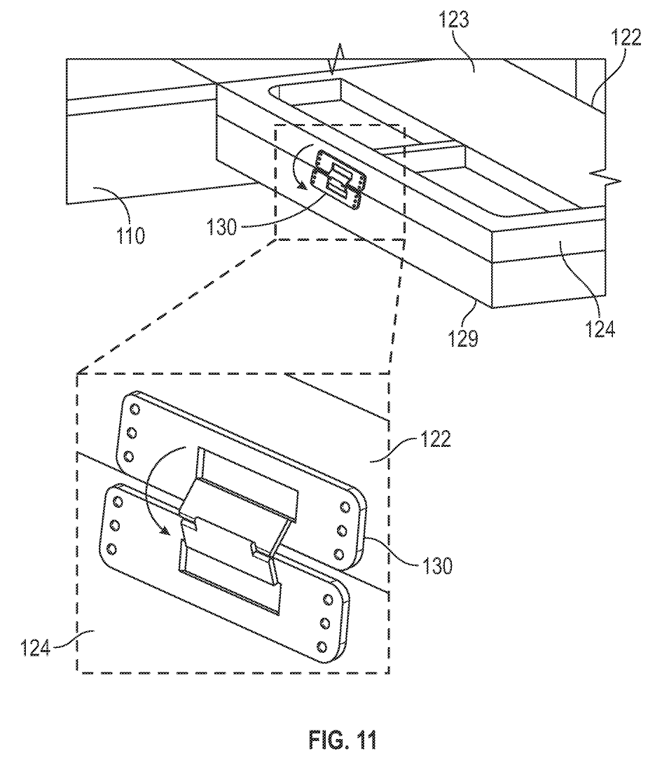

In the examples of FIGS. 8, 9, and 11, the first panel member 122 and the second panel member 124 are pivotally coupled at the front edges thereof such that the first panel member 122 is capable of unfolding (via pivoting) in directions toward the front of the vehicle 10 to enlarge the support surface provided by the panel assembly 40. FIG. 11 represents an enlarged view of the pivoting joint 130 according to a nonlimiting example. In this example, the rail assemblies 128 may be secured to may be secured to the fourth face 129 as represented in FIG. 12.

In each of the examples of FIGS. 6-9, the panel assembly 40 may be transitioned from the folded configuration to the unfolded configuration, while the panel assembly 40 is arranged in a fully extended position, by pivoting the first panel member 122 relative to the second panel member 124 until the lateral edges thereof coupled by the pivoting joint 130 contact or are otherwise disposed adjacent to each other.

In the unfolded configuration, the second panel member 124 is extended from the base 110 on the rail assembly 128 over a first portion of either the first seat cushion 30 or the second seat cushion 32, and the first panel member 122 is cantilevered from the second panel member 124 and extended across a second portion of either the first seat cushion 30 or the second seat cushion 32. While in the folded configuration, both the first panel member 122 and the second panel member 124 are configurated to support a load thereon. That is, the second face 125 and the third face 127 define a support area in the unfolded configuration. Therefore, the occupant 42 may transition the panel assembly 40 into the unfolded configuration and rest a portion of the occupant’s body and/or other objects thereon, such as electronic device (e.g., laptop, tablet, smart phone, etc.).

In some examples, the pivoting joint 130 may be lockable or otherwise configured to maintain the first panel member 122 and/or the second panel member 124 in fixed positions while a load is applied on one or both of the second face 125 and the third face 127. In some examples, the pivoting joint 130 may be a dual axis torque hinge. In some examples, the panel assembly 40 may include more than one of the pivoting joint 130.

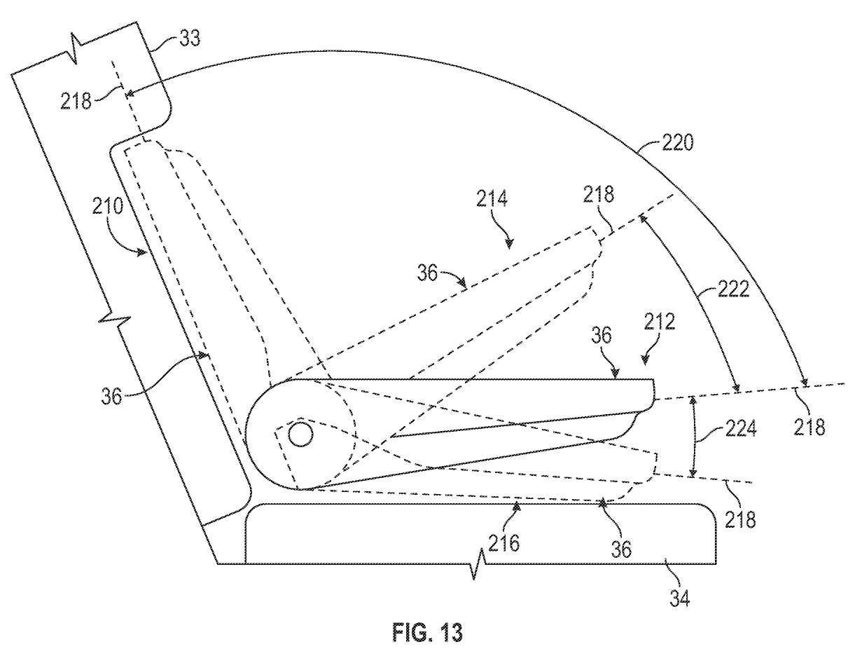

In some examples, the armrest 36 may be configured to be arranged and releasably fixed in a position between the stowed configuration and the deployed configuration to thereby adjust the position of the panel assembly 40 when extended and in the unfolded configuration. For example, the hinge portion 116 may be configured to be lockable or otherwise maintained at more than one pivoting angle relative to the seatback of the rear seat 28. For example, FIG. 13 represents the armrest 36 secured in various positions relative to the second seatback 33, including a first position 210 (i.e., stowed configuration) wherein the armrest 36 is received within the recess 38, a second position 212 (i.e., deployed position), a third position 214 between the first position 210 and the second position 212 and raised relative to the middle seat cushion 34, and a fourth position 216 that is pivoted beyond the second position 212 and lowered relative to the middle seat cushion 34. For ease of description, the armrest 36 may be described as including an axis 218 for use in determining a pivoting angle of the armrest 36. In some examples, a first pivoting angle 220 between the first position 210 and the second position 212 may be about 105 to 120 degrees. In some examples, a second pivoting angle 222 between the second position 212 and the third position 214 may be about 20 to 40 degrees. In some examples, a third pivoting angle 224 between the second position 212 and the fourth position 216 may be about 1 to 10 degrees. In some examples, the position of the armrest 36 (and therefore the position of the panel assembly 40 when extended and in the unfolded configuration) may be modified by adjusting the pivoting angle of the second seatback 33 relative to the middle seat cushion 34.

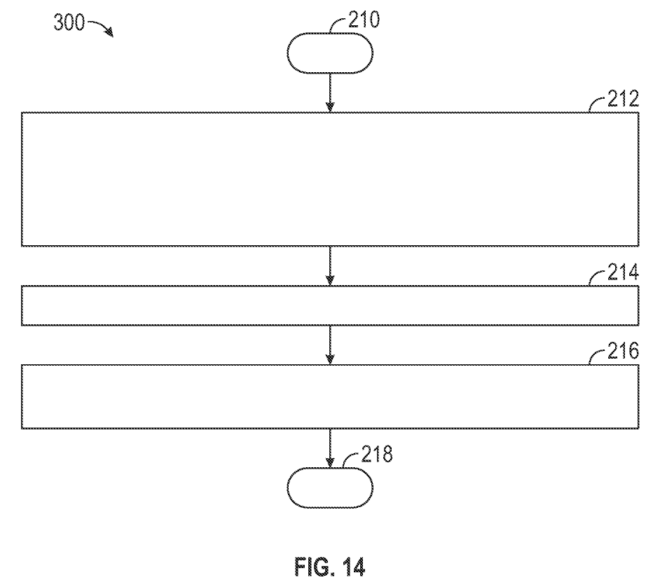

With reference now to FIG. 14 and with continued reference to FIGS. 1-13, a flowchart provides a method 300 for supporting a load from an armrest (e.g., the armrest 36) of a vehicle (e.g., the vehicle 10), in accordance with various examples. As can be appreciated in light of the disclosure, the order of operation within the method 300 is not limited to the sequential execution as illustrated in FIG. 14, but may be performed in one or more varying orders as applicable and in accordance with the present disclosure. In one example, the method 300 may start at 310.

At 312, the method 300 may include pivoting an armrest coupled to a bench seat of a vehicle from a stowed configuration to a deployed configuration. The armrest is within a recess of a seatback of the bench seat while in the stowed configuration and disposed outside of the recess when in the deployed configuration. In some examples, the method 300 may include releasably securing the armrest in a first position when pivoted relative to the seatback.

At 314, the method 300 may include extending a panel assembly from a side of the armrest. In various examples, this may include extending the panel assembly from the armrest in a direction toward a side of the vehicle to be disposed over a side seat cushion of the bench seat. In some examples, the panel assembly may include a first panel member and a second panel member, wherein the first panel member is coupled to the second panel member and the second panel member is secured to a body of the armrest with a rail assembly. In such examples, extending the panel assembly from the side of the armrest may include sliding the second panel member along the rail assembly.

In some examples, the method 300 may include transitioning the panel assembly between a folded configuration and an unfolded configuration while the panel assembly is extended from the side of the armrest. The first panel member and the second panel member may be stacked while in the folded configuration and the first panel member may be cantilevered from the second panel member while in the unfolded configuration to, in combination, define a support surface configured to support the load thereon. If the first panel member and the second panel member are coupled with a pivot joint, transitioning the panel assembly to the unfolded configuration may include pivoting the first panel member relative to the second panel member such that adjacent faces of the first panel member and the second panel member are aligned in a geometric plane. In some examples, the first panel member and the second panel member may be coupled with the pivot joint at forward edges thereof and the method may include pivoting the first panel member relative to the second panel member to be disposed in a position that is closer to the front of the vehicle.

At 316, the method 300 supporting a load on the panel assembly while extended from the side of the armrest. The method 300 may end at 318.

In some examples, the panel assembly may be configured to extend from either of the sides of the armrest. In such examples, the method 300 may include extending the panel assembly from a second side of the armrest, and supporting the load on the panel assembly while extended from the second side of the armrest.

The systems and methods disclosed herein provide various benefits over certain existing systems and methods. For example, non-driving occupants of a vehicle, such as those seated in a rear bench seat, are able to focus their attention on other tasks. However, a lack of a support surface may limit their options and/or render certain tasks impractical. By providing a deployable armrest with an extendable panel assembly, occupants are provided with a support surface that promotes ease of performing various tasks. For example, the occupant may transition the panel assembly into the unfolded configuration and rest a portion of the occupant’s body to promote comfort or sleep, and/or may rest other objects thereon, such as electronic device (e.g., laptop, tablet, smart phone, etc.) to promote ease of use thereof. The systems and methods disclosed herein provide these capabilities while also allowing for the panel assembly, when not in use, to be stowed in a manner that does not interfere with a normal use of the seat.

While at least one exemplary embodiment has been presented in the foregoing detailed description, it should be appreciated that a vast number of variations exist. It should also be appreciated that the exemplary embodiment or exemplary embodiments are only examples, and are not intended to limit the scope, applicability, or configuration of the disclosure in any way. Rather, the foregoing detailed description will provide those skilled in the art with a convenient road map for implementing the exemplary embodiment or exemplary embodiments. It should be understood that various changes can be made in the function and arrangement of elements without departing from the scope of the disclosure as set forth in the appended claims and the legal equivalents thereof.

What is claimed is:

1. A method, comprising:
pivoting an armrest coupled to a bench seat of a vehicle from a stowed configuration to a deployed configuration, wherein the armrest is within a recess of a seatback of the bench seat while in the stowed configuration and disposed outside of the recess when in the deployed configuration;
extending a panel assembly from a side of the armrest; and
supporting a load on the panel assembly while extended from the side of the armrest.

2. The method of claim 1, wherein extending the panel assembly from the side of the armrest includes extending the panel assembly from the armrest in a direction toward a side of the vehicle to be disposed over a side seat cushion of the bench seat.

3. The method of claim 1, wherein the panel assembly includes a first panel member and a second panel member, wherein the first panel member is coupled to the second panel member and the second panel member is secured to a body of the armrest with a rail assembly, wherein extending the panel assembly from the side of the armrest includes sliding the second panel member along the rail assembly.

4. The method of claim 3, further comprising transitioning the panel assembly between a folded configuration and an unfolded configuration while the panel assembly is extended from the side of the armrest, wherein the first panel member and the second panel member are stacked while in the folded configuration and the first panel member is cantilevered from the second panel member while in the unfolded configuration to, in combination, define a support surface configured to support the load thereon.

5. The method of claim 4, wherein the first panel member and the second panel member are coupled with a pivot joint, and the method includes transitioning the panel assembly to the unfolded configuration by pivoting the first panel member relative to the second panel member such that adjacent faces of the first panel member and the second panel member are aligned in a geometric plane.

6. The method of claim 5, wherein the first panel member and the second panel member are coupled with the pivot joint at forward edges thereof and the method includes pivoting the first panel member relative to the second panel member to be disposed in a position that is closer to the front of the vehicle.

7. The method of claim 1, further comprising:
extending the panel assembly from a second side of the armrest; and
supporting the load on the panel assembly while extended from the second side of the armrest.

8. The method of claim 1, further comprising releasably securing the armrest in a first position when pivoted relative to the seatback.

9. An armrest for a bench seat of a vehicle, comprising:
a body having a rear end configured to be pivotally coupled to a seatback of the bench seat, a front end opposite the rear end, and sides therebetween, wherein the body is configured to be pivotable between at least a stowed configuration and a deployed configuration while pivotably coupled to the seatback, wherein the body is disposed within a recess of the seatback while in the stowed configuration and disposed outside of the recess when in the deployed configuration; and
a panel assembly slidably coupled with the body by a rail assembly, wherein the panel assembly is configured to extend and retract from at least one of the sides of the body and to support a load thereon while extended from the at least one of the sides of the body.

10. The armrest of claim 9, wherein the panel assembly includes a first panel member and a second panel member, wherein the first panel member is coupled to the second panel member and the second panel member is secured to the body with the rail assembly.

11. The armrest of claim 10, wherein the panel assembly is configured to transition between a folded configuration and an unfolded configuration while the panel assembly is extended from the at least one of the sides of the body, wherein the first panel member and the second panel member are stacked while in the folded configuration and the first panel member is cantilevered from the second panel member while in the unfolded configuration to, in combination, define a support surface configured to support the load thereon.

12. The armrest of claim 11, wherein the first panel member and the second panel member are coupled with a pivot joint, and the panel assembly is configured to transition to the unfolded configuration by pivoting the first panel member relative to the second panel member such that adjacent faces of the first panel member and the second panel member are aligned in a geometric plane.

13. The armrest of claim 12, wherein the first panel member and the second panel member are coupled with the pivot joint at forward edges thereof and the first panel member is configured to pivot relative to the second panel member to be disposed in a position that is closer to the front of the vehicle while the body is coupled to the bench seat within the vehicle.

14. The armrest of claim 9, wherein the panel assembly is configured to extend from both of the sides of the body.

15. The armrest of claim 9, wherein the rear end of the body includes a pivoting joint that is configured to be pivotably coupled to the seatback and releasably securable in more than one position when pivoted relative to the seatback.

16. A vehicle, comprising:
a bench seat having a first seat cushion, a second seat cushion, a middle seat cushion between the first seat cushion and the second seat cushion, and a seatback for supporting an occupant’s back while seated in the first seat cushion, the second seat cushion, or the middle seat cushion; and
an armrest comprising:
a body having a rear end pivotally coupled to the seatback of the bench seat, a front end opposite the rear end, and sides therebetween, wherein the body is configured to be pivotable between at least a stowed configuration and a deployed configuration, wherein the body is disposed within a recess of the seatback while in the stowed configuration and disposed outside of the recess when in the deployed configuration; and
a panel assembly slidably coupled with the body by a rail assembly, wherein the panel assembly is configured to extend and retract from at least one of the sides of the body and to support a load thereon while extended from the at least one of the sides of the body, wherein the panel assembly is configured to extend from the at least one of the sides of the body in directions toward and away from sides of the vehicle and to be disposed over the first seat cushion of the second seat cushion.

17. The vehicle of claim 16, wherein the panel assembly includes a first panel member and a second panel member, wherein the first panel member is coupled to the second panel member and the second panel member is secured to the body with the rail assembly, wherein the panel assembly is configured to transition between a folded configuration and an unfolded configuration while the panel assembly is extended from the at least one of the sides of the body, wherein the first panel member and the second panel member are stacked while in the folded configuration and the first panel member is cantilevered from the second panel member while in the unfolded configuration to, in combination, define a support surface configured to support the load thereon.

18. The vehicle of claim 17, wherein the first panel member and the second panel member are coupled with a pivot joint, and the panel assembly is configured to transition to the unfolded configuration by pivoting the first panel member relative to the second panel member such that adjacent faces of the first panel member and the second panel member are aligned in a geometric plane.

19. The vehicle of claim 16, wherein the panel assembly is configured to extend from both of the sides of the body.

20. The vehicle of claim 16, wherein the rear end of the body includes a pivoting joint that is pivotably coupled to the seatback and releasably securable in more than one position when pivoted relative to the seatback.
